(19) United States
(12) Patent Application Publication
(10) Pub. No.: US 2007/0068008 A1
(43) Pub. Date: Mar. 29, 2007

(54) HAND-HELD TOOL

(75) Inventors: Jian Wu, Jiangsi (CN); Xuefeng Yu, Jiangsu (CN)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Positec Power Tools (Suzhou) Co., Ltd., Jiangsu (CN)

(21) Appl. No.: 11/533,189

(22) Filed: Sep. 19, 2006

(30) Foreign Application Priority Data
Sep. 23, 2005 (CN) 200510094526.1

(51) Int. Cl. B26B 27/00

(52) U.S. Cl. 30/276; 30/298

(57) ABSTRACT

A hand-held power tool includes an elongated operation rod having opposite ends to which a working unit and a forearm support are mounted respectively, and first and second handles are mounted to the operation rod and are spaced from each other. The second handle includes a first handgrip portion coupled to the operation rod and a second handgrip portion coupled to the first handgrip portion. The second handgrip portion is provided with a free end. The first handgrip portion cooperates with the forearm support for supporting the forearm of a user's hand that holds the first handgrip portion for performing one-handed operation of the tool, while the second handgrip portion cooperates with the first handle for providing a user with two-handed operation, where two hands of the user hold the first and second handles respectively.

### CROSS REFERENCE TO RELATED APPLICATIONS

This application claims priority to Chinese patent application number 200510094526.1, filed Sep. 23, 2005, which is incorporated herein by reference.

### FIELD OF THE INVENTION

The present invention relates to a hand-held tool, particularly to a power garden tool, such as a vegetation line trimmer, that can be operated with either a single-handed operation mode or a two-handed operation mode.

### BACKGROUND OF THE INVENTION

At present, many types of hand-held tool, such as a vegetation line trimmer, are provided with an elongated shaft having an end forming a working unit. In such tools, an opposite end of the shaft is provided with a shaped handle to allow a user to hold and operate the tool with one hand when the user is moving the working unit over an area to be worked on. When the working unit is arranged at the end of a relatively long shaft, the user has to apply a considerable muscular effort to maintain the tool in operation. The muscles of the arm supporting the tool would feel soar and even aches after operating the tool for a long period of time. To alleviate this problem, a secondary handle is provided on the elongated shaft of such a tool to allow the user to hold the tool with both hands. Two-handed operation is generally less tiring but is often less convenient than single-handed operation.

U.S. Pat. No. 6,327,781 discloses a vegetation line trimmer that can be operated alternately with one hand or two hands. The vegetation line trimmer comprises an elongated shaft having an end to which a power working unit is mounted and an opposite end at which a first handle and a second handle are arranged. The second handle is adjustable with respect to the first handle between a first position and a second position. The second handle in its first position cooperates with the first handle to provide for two-handed operation, and the second handle in its second position cooperates with the first handle to serve as a support for the wrist and/or forearm of a user grasping the first handle with one hand in a single-handed operation. The first handle is only provided with one handgrip portion designated an actuating lever for the user to grasp during either one-handed operation or two-handed operation. The distance between the handgrip portion of the first handle and the pivot axis of the second handle is very short, and the distance between the pivot axis of the second handle and the handgrip portion of the second handle is very long. Such an arrangement prevents a user from comfortably holding the tool in the two-handed operation. In the one-handed operation, the second handle is moved to the second position for supporting the wrist and/or the forearm of the user, and since the length of the second handle is not variable, it is difficult to find a comfortable supporting position for different users.

### SUMMARY OF THE INVENTION

In order to overcome the foregoing disadvantages, it is an object of the present invention to provide a hand-held tool, such as a vegetation line trimmer, which features comfortable operation and simple and ergonomic structure.

In accordance with the present invention, a hand-held tool is provided, comprising an elongated operation rod, a first handle and a second handle mounted to the operation rod, and a working unit mounted to at one end of the operation rod. The second handle comprises at least a first handgrip portion coupled to the operation rod and a second handgrip portion coupled to the first handgrip portion. The first handgrip portion has a height or a dimension measured from the operation rod to the second handgrip portion, substantially equal to or greater than the width of a palm of the user. The second handgrip portion has a free end. The first handle is rotatable with respect to the operation rod, and the first handle is located away from a forearm support that is arranged at an opposite end of the operation rod and the second handle is adjacent to the forearm support. The forearm support is movably mounted to the operation rod and cooperates with the first handgrip portion for operating the tool with one hand. Alternately, the first handle cooperates with the second handgrip portion for operating the tool with two hands.

The hand-held tool can be a garden tool, such as a vegetation line trimmer.

The first handgrip portion of the second handle and the operating rod form a first included angle α therebetween, and the second handgrip portion and the first handgrip portion form a second included angle β therebetween. In accordance with an aspect of the present invention, at least one of the included angles is adjustable. In a vegetation line trimmer embodying the present invention, the first handgrip portion is rotatable with respect to the operation rod, which renders the first included angle a adjustable, while the second included angle β between the first handgrip portion and the second handgrip portion is set fixed and in the range between 80 to 110 degrees, preferably 90 degrees.

In a second embodiment, the first handgrip portion is fixed on the operation rod with the first included angle a fixed and in the region between 80 to 110 degrees, preferably 90 degrees, while the second handgrip portion is rotatable with respected to the first handgrip portion to render the second included angle β adjustable.

In a third embodiment, the first handgrip portion is fixed to the operation rod, and the second handgrip portion is fixedly mounted to the first handgrip portion with the first included angle α between the first handgrip portion and the operation rod set in the region between 80 to 110 degrees, and the second included angle β between the first handgrip portion and second handgrip portion set in the region between 80 to 110 degrees. The second handgrip portion has a free end.

The advantages of the present invention are that a user can freely select either the one-handed operation mode or the two-handed operation mode, and that different users can find different comfortable operating positions for themselves through the adjustment of handles.

### BRIEF DESCRIPTION OF DRAWINGS

The present invention will become more fully understood from the detailed description given hereinafter and the accompanying drawings which are given by way of illustration only, and thus are not limitative of the present invention, and wherein:

FIG. 1 is a side view of a hand-held tool constructed in accordance with a first embodiment of the present invention;

FIG. 2A is a partially cross-sectional view of the hand-held tool taken along line II-II of FIG. 1;

FIG. 2B is a cross-sectional view of a handle of the hand-held tool of the present invention;

FIG. 3 is a cross-sectional view taken along line III-III of FIG. 2B;

FIG. 4 is a cross-sectional view taken along line IV-IV of FIG. 2B;

FIGS. 5A and 5B are cross-sectional views taken along line V-V of FIG. 2A, respectively showing the conditions where a forearm support is retracted into and withdrawn out of an operation rod of the hand-held tool of the present invention;

FIG. 6A is a schematic illustration showing one-handed operation of the hand-held tool of the present invention;

FIG. 6B is a schematic illustration showing two-handed operation of the hand-held tool of the present invention;

FIGS. 7A and 7B are partially side views of a hand-held tool constructed in accordance with a second embodiment of the present invention; and

FIG. 8 is perspective view of a portion of a hand-held tool constructed in accordance with a third embodiment of the present invention.

### DETAILED DESCRIPTION OF THE PREFERRED EMBODIMENTS

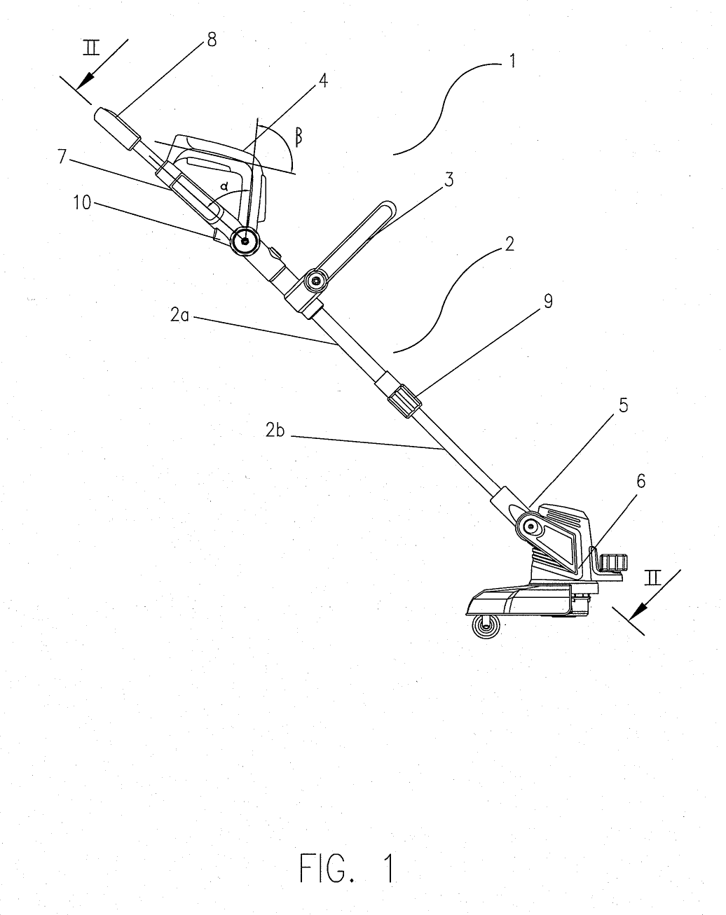

With reference to the drawings, and in particular to FIG. 1, a hand-held tool constructed in accordance with the present invention, such as a portable garden tool, for example a vegetation line trimmer shown in FIG. 1, generally designated with reference numeral 1, comprises comprise generally an elongated operation rod 2 having a first end 5 to which a working unit 6 is mounted and an opposite second end 7 to which a forearm support 8 is movably attached. The operating rod 2 consists of a first section 2a and a second section 2b telescopically received in the first section 2a, which is thus preferably tubular. In the embodiment illustrated, the working unit 6 is mounted to the second rod section 2b, while the forearm support 8 is formed on the first rod section 2a.

Releasable securing means 9 is provided between the first and second rod sections 2a, 2b for selectively and releasably secure the first and second rod sections 2a, 2b to each other. By releasing the securing means, the rod sections 2a, 2b are allowed to axially move with respect to each other to increase/decrease overall length of the rod 2. This allows a user to adjust the length of the rod 2 so as to find the most suitable length according to the user's stature for manipulation.

A first handle 3 and a second handle 4 are arranged on the first rod section 2a and are spaced from each other by a distance with the first handle 3 positioned away from the forearm support 8, while the second handle 4 close to the forearm support 8.

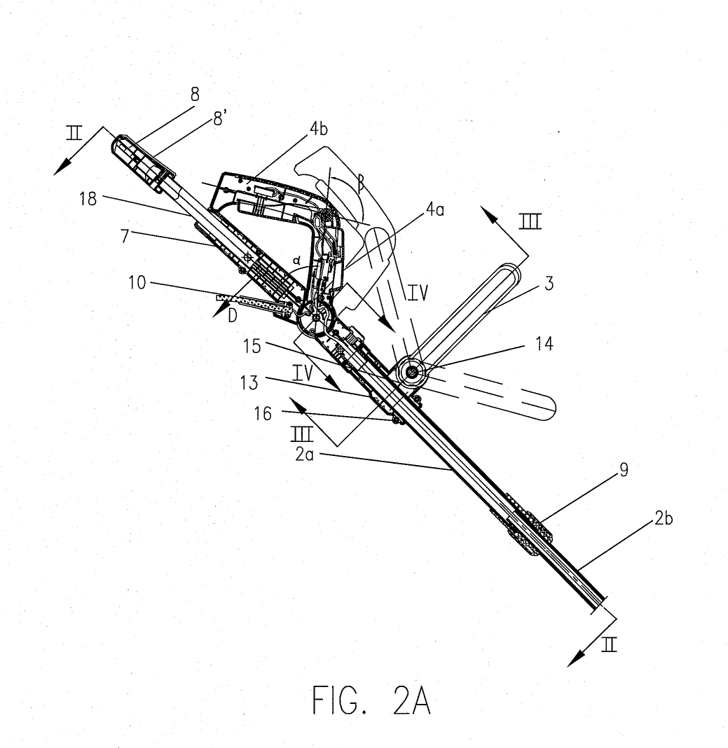

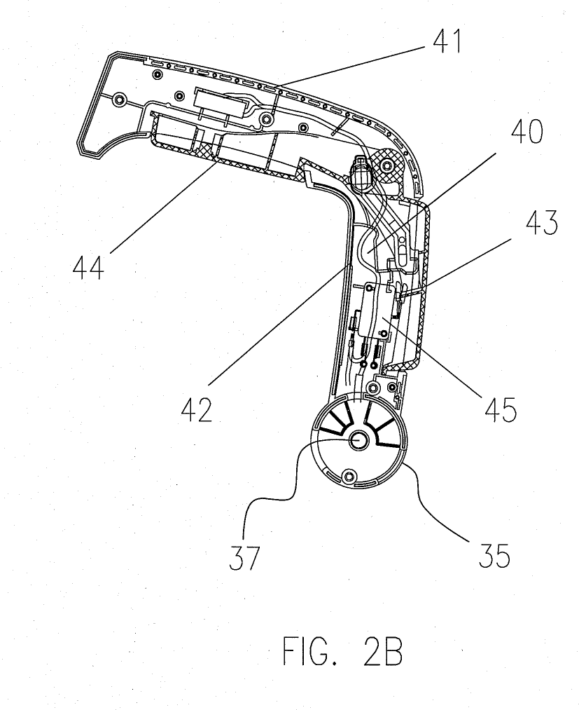

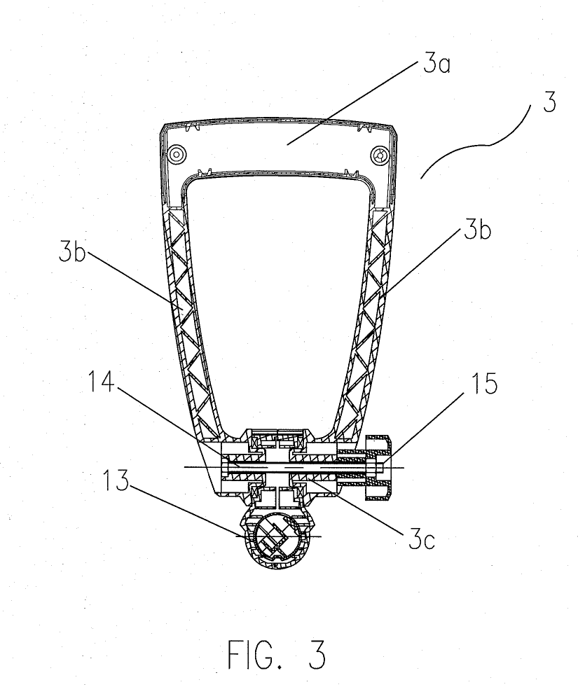

Also referring to FIGS. 2 and 3, a collar joint 13 is secured to the first section 2a of the operation rod 2 through screws or other fastener elements. The first handle 3, which is in the form of rectangular frame, includes two arms 3b having opposite ends between which a handgrip portion 3a and a lower end portion 3c extend respectively. The lower end 3c of the handle 3 is pivoted to the collar joint 13 through a shaft 14 (FIG. 3), which extends through aligned holes (not labeled) defined in both the arms 3b of the first handle 3 and the collar joint 13. Thus, the handle 3 is rotatable with respect to the operation rod 2.

In the embodiment illustrated, the shaft 14 that pivots the first handle 3 to the operation rod 2 has an end fixed by a rivet (not labeled) and an opposite end with which a locking nut 15 engages for releasably securing the first handle 3 at a selected angular position with respect to the operation rod 2. In this way, the handle 3 can be selectively moved to any desired angular position with respect to the operation rod 2 and releasably secured there by tightening the locking nut 15.

The second handle 4 comprises a first handgrip portion 4a and a second handgrip portion 4b. The second handgrip portion 4a is rotatably connected, at an end thereof, to the operation rod 2 with a first included angle a therebetween. The second handgrip portion 4b extends from an opposite end of the fist handgrip portion 4a with a second included angle β between the first handgrip portion 4a and second handgrip portion 4b, which is fixed in this case and is set within the region between 80 to 110 degrees. Preferably, the second included angle is 90 degrees as shown in the drawings.

Soft outer layers 41, 42, which are made of materials providing comfortable gripping for the user, such as plastics, are provided on outer surfaces of the second handgrip portion 4b and the first handgrip portion 4a. The outer layers 41, 42 provide the user with a comfortable gripping feeling in operating the hand-held tool 10. Apparently, flexible or soft materials other than plastics but featuring the same comfortableness of gripping, such as rubber, can also be used to make the outer layers 41, 42 of the handgrip portions 4b, 4a. The outer layers 41, 42 may completely surround the handgrip portions 4b, 4a, but are preferably tailored to expose certain portions of the outer surfaces of the handgrip portions 4a, 4b, where operation elements, such as actuation levers, are located.

The first handgrip portion 4a is provided with a first actuation lever 43, and the second handgrip portion 4b is provided with a second actuation lever 44. The levers 43, 44 are mounted to the first and second handgrip portions 4a, 4b and are accessible by the user so that the switch 43, 43 can be actuated or depressed when the user holds the first or second handgrip portion 4a, 4b. Preferably, the height of the first handgrip portion 4a is substantially equal to or greater than the width of the user's palm to allow the user to grasp the first handgrip portion 4a stably.

The second handle 4 defines an interior cavity 40 and the first and second handgrip portions 4a, 4b are configured to allow the first and second actuation levers 41, 42 to partially move into the cavity 40 when the actuation levers 41, 42 are actuated or depressed in case the user holds the handgrip portion 4a, 4b with his or her palm. A switch 45, which is electrically connected to and thus controls the operation of the working unit 6, is arranged in the cavity 40 so that the movement of the actuation levers 41, 42 into the cavity 40 by being depressed by the user effects engagement between the actuation levers 41, 42 and the switch 45 and thus turning on the switch 45. In other words, when the user grasps either the first handgrip portion 4a or the second handgrip portion 4b, the actuation lever 41, 42 is forced into the cavity 40 and triggering the switch 45.

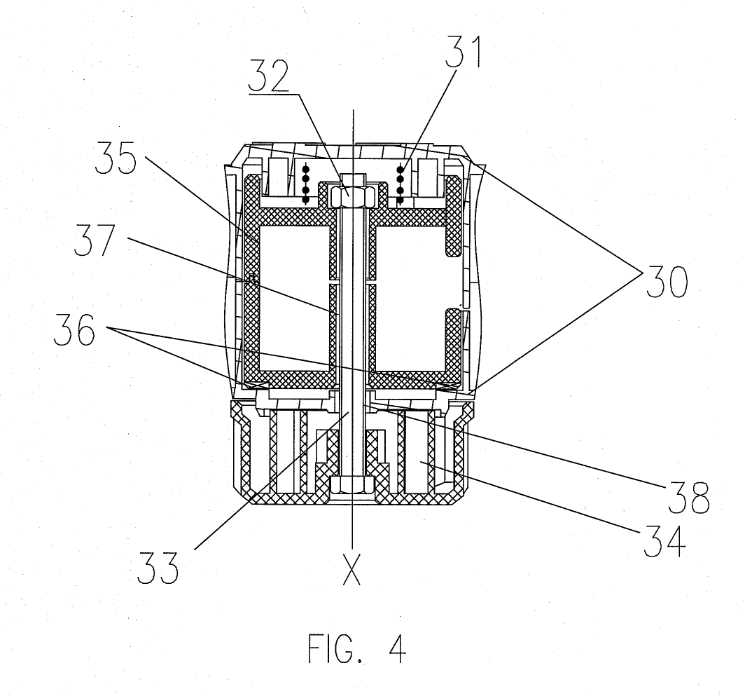

Also referring to FIG. 4, the operation rod 2, especially the first rod section 2a, is provided with a handle carrier 30 for rotatably coupling a handle joint 35 formed on the end of the first handgrip portion 4a of the second handle 4 that, as mentioned previously, is rotatably connected to the operation rod 2. The handle joint 35 of the second handle 4 defines a center, rotational axis X about which the second handle 4 rotates with respect to the carrier 30 or the operation rod 2. The handle joint 35 is fit in the carrier 30 and has a teethed end face opposing and engageable with a serration portion of the carrier 30. A biasing element 31, such as a resilient member, for example a spring, is arranged on an opposite end of the handle joint 35, which is opposite to the teeth 36, to bias the handle joint 35 toward the serration portion of the carrier 30 for selectively establishing teethed engagement between the handle joint 35 and the carrier 30.

The handle joint 35 defines a central bore 37 extending along the central axis X, through which a bolt 33 having a first end and a second end extends. A nut 32 is disposed at and threadingly engages the first end of the bolt 33 adjacent the spring 31. The second end of the bolt 31 extending through an opening 38 defined in a side wall of the handle carrier 30 and projects beyond the side wall. A manual knob 34 is attached to the second end for manually rotating the bolt 31 against the biasing force of the spring 31 and thus releasing the teethed engagement between the joint 35 and the carrier 30.

The second handle 4 is configured to selectively rotate with respect to the handle carrier 30 by manually rotating the knob 34 to release the toothed engagement between the joint 35 and the carrier 30. The user can find a comfortable position by adjusting the angular position of the second handle 4. Once a desired comfortable positioned is achieved, the second handle 4 can be re-secured by manually fastening the knob 34 on the bolt 33 to deform the spring 31, which effects the toothed engagement between the joint 35 and the carrier 30 again thereby fixing the second handle 4 at the selected position. On the contrary, when the knob 34 is released, the angular position of the second handle 4 can be adjusted again.

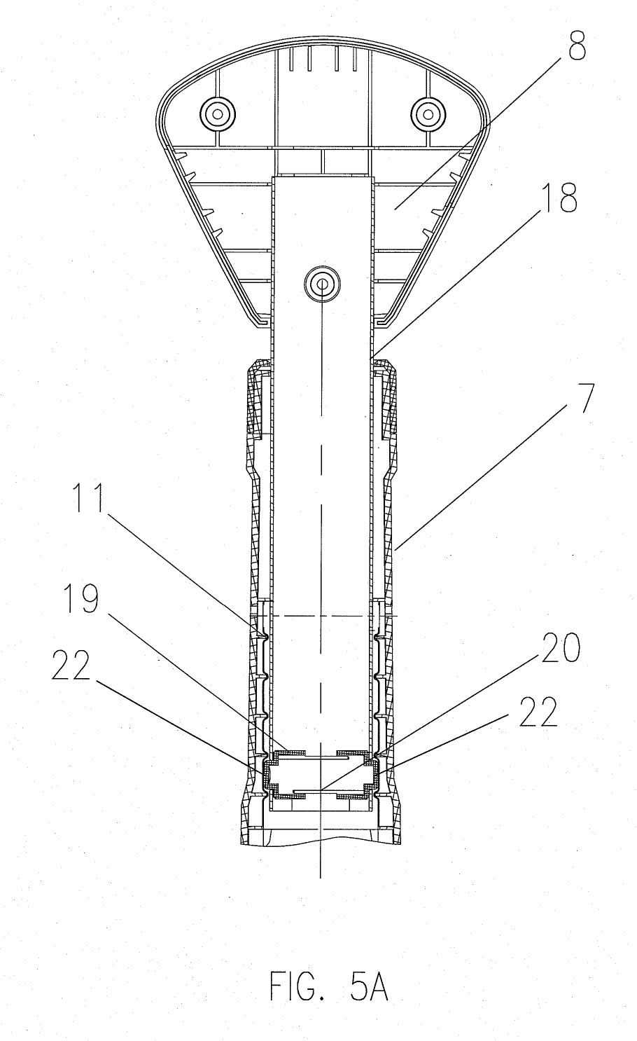

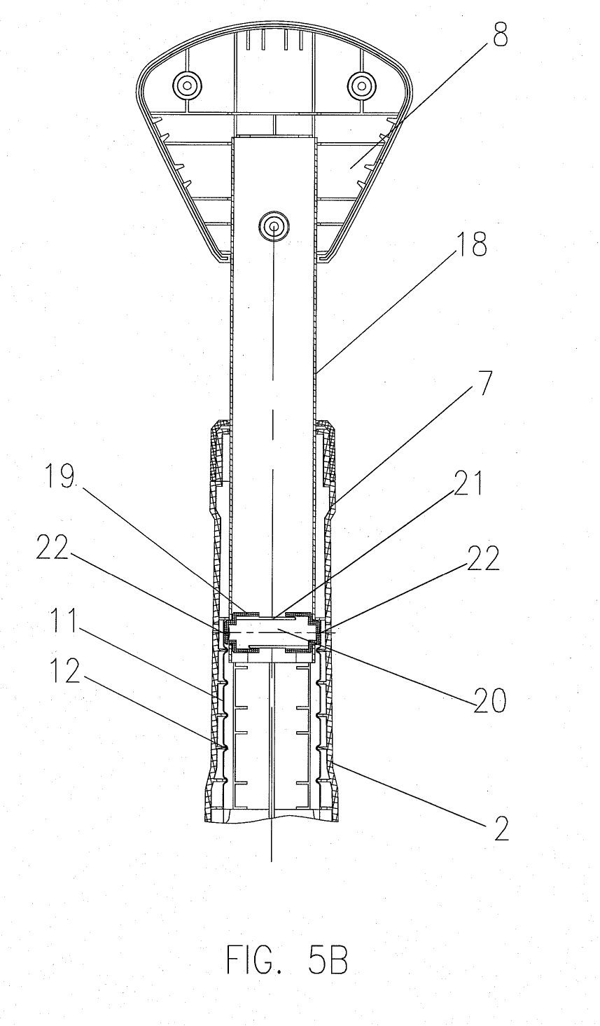

Referring to FIGS. 5A and 5B, the forearm support 8 that is movably mounted to the end 7 of the operation rod 2 comprises a stem or a tube 18 telescopically received in the end 7 of the tubular first rod section 2a of the operation rod 2. The relative position of the forearm support 8 with respect to the operation rod 2 is adjustable with a clamp device 19 that is mounted to a free end of the stem 18 and received in the end 7 of the operation rod 2. The clamp device 19, which is generally a radially-compressible device, comprises two opposite side walls 22 that are movable in a radial direction so that the distance between the two side walls 22, which is generally measured in the radial or diametric direction, is changeable by the radial compression of the clamp device 19. However, a nominal or maximum outside diameter of the clamp device 19, or the maximum distance between the side walls 22, is made larger than an outside diameter of the tubular stem 18 so that when the clamp device 19 is received and fixed in the stem 18, the side walls 22 partially project beyond a circumferential sidewall of the tubular stem 18.

The clamp device19 defines an interior space 20 in which biasing means, such as a compression spring 21, is accommodated and acting against the side walls 22 in opposite directions to project the side walls 22 beyond the stem 18 in the radial direction. Specifically, the compression spring 21 has two ends urging the two side walls 22 respectively in the radial direction.

Means for selectively engaging the clamp device 19 is provided on an inside surface of the end 7 of the tubular first rod section 2a of the operation rod 2 whereby the relative position of the forearm support 18 can be adjusted by axially moving the forearm support 18 with respect to the operation rod 2 and re-positioned by the engaging means. In the embodiment illustrated, the engaging means comprises a plurality of circumferentially-extending ribs 12 that are formed on the inside surface f the tubular end 7 of the operation rod 2 and are axially spaced from and fixed together with each other by intermediate sections 11 that are mounted to the inside surface of the tubular end 7 of the operation rod 2. Thus, the ribs 12 extend inward beyond the intermediate sections 11 so as to define spaced recesses along the tubular end 7 of the operation rod 2. Preferably, the ribs 12 are equally spaced and the distance between adjacent ribs 12, or the size of the recess, is sufficient to accommodate the side wall 22 of the clamp device 19, which is forcibly extended outward by the biasing force of the compression spring 21 and thus engages the recess to position the forearm support 18 with respect to the operation rod 2.

To operate, the user apply a force on the forearm support 8 to drive the stem 18 into/out of the tubular end 7 of the operation rod 2. The stem 18, once being forced to move with respect to the operation rod 2, causes the side walls 22 of the clamp device 19 to move inward against the biasing force of the compress spring 21 due to the engagement between the side walls 22 and the ribs 12. In this respect, it is preferred that either the side walls 22 of the clamp device 19 or the ribs 12 or both are provided with inclined camming faces to facilitate the inward movement of the side walls 22 of the clamp device 19 upon withdrawal of the stem 18.

Once the side walls 22 are forced inward to disengage from the ribs 12, the stem 18 is allowed to move with respect to the operation rod 2. The stem 18 is then re-positioned in the next recess delimited by the next pair of ribs 12 and the process repeats until the force applying on the forearm support 8 is removed, at which moment, the compression spring 21 restores the original shape thereof and once again bias the side walls 22 of the clamping device 19 into engagement with the corresponding one of the recesses of the tubular end 7 of the operation rod 2. Thus, the forearm support 8 is positioned securely again with respect to the operation rod 2 at a different location. This allows the user to set the location of the forearm support 18 at the most comfortable position for the user.

A soft cover layer 8′ can be selectively provided on an outer surface of the forearm support 8 to provide a comfortable contact and support to the user's forearm or elbow. The cover layer 8′ can be made of any suitable material, such as plastics.

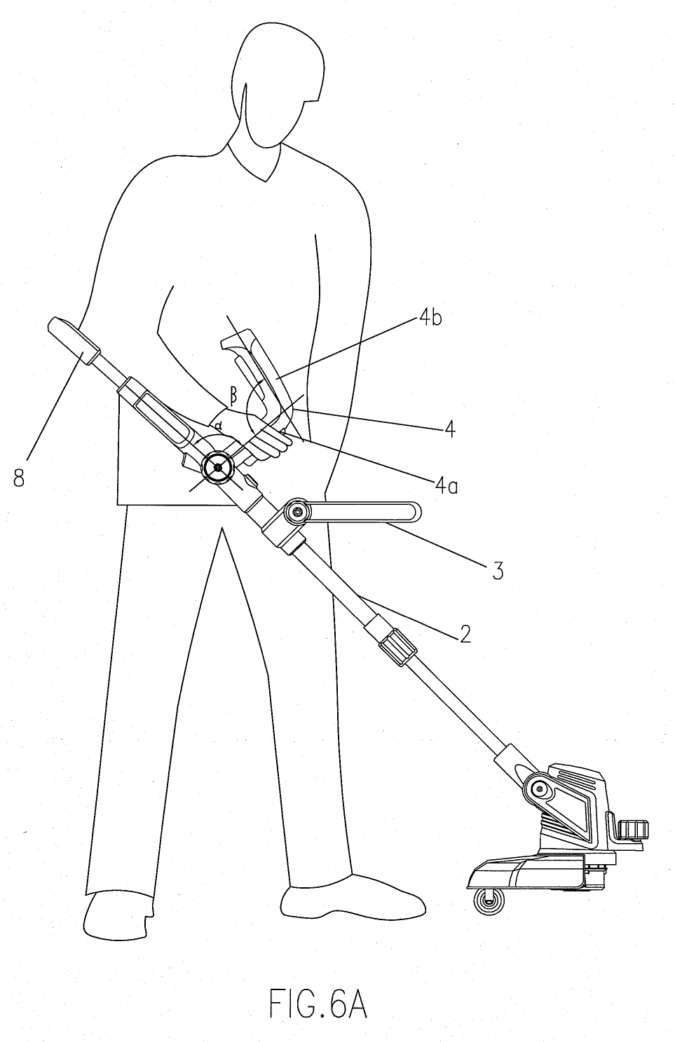

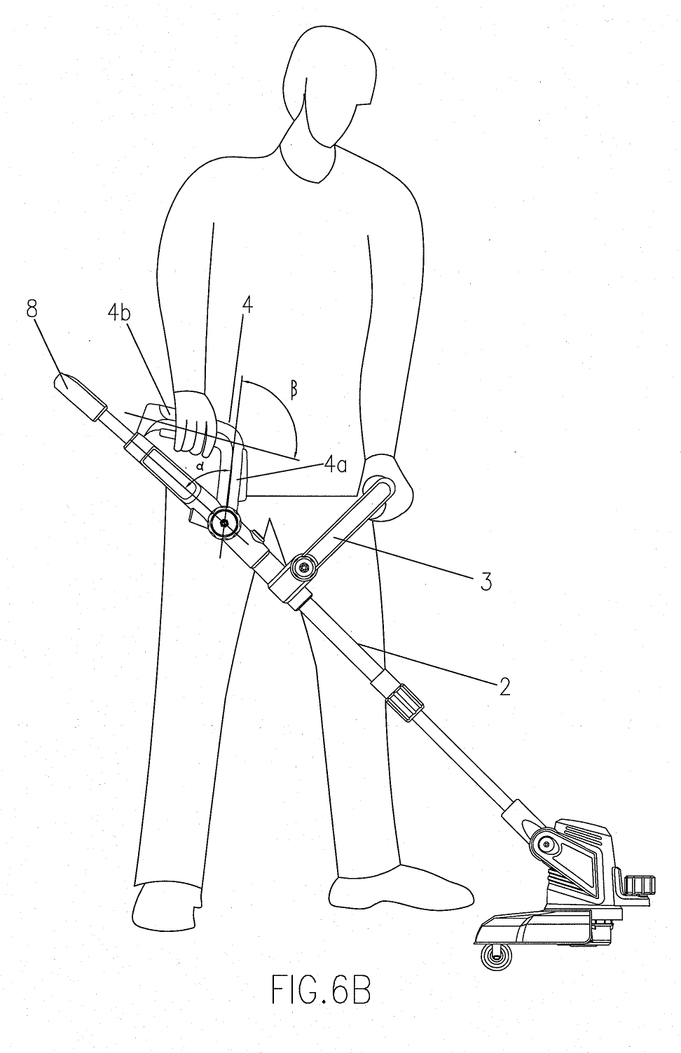

Referring to FIGS. 6A and 6B, as discussed previously, the line trimmer 1 is provided with the forearm support 8 that is movably connected to the operation rod 2 for supporting the forearm or elbow of the user, the first and second handles 3, 4 that are pivoted to the operation rod 2 to be gripped by the user's hand and thus allowing the user to hold and operate the line trimmer 1.

To operate the line trimmer 1 with one hand, as demonstrated in FIG. 6A, the user grasps the first handgrip 4a of the second handle 4 with one hand, and the forearm is placed on and supported by the forearm support 8. Ergonomically, the most comfortable position is where the included angle between the forearm and the upper arm of the user is about 90 degrees, and correspondingly, the first handgrip portion 4a is substantially perpendicular to the operating rod 2. In other words, the first included angle a is about 90 degrees. The adjustability of the relative position of the forearm support 8 with respect to the operation rod 2 allows different users to find the most suitable location of the forearm support 8 for themselves.

The user's hand that grasps the first handgrip 4a of the second handle 4 can thus depress the first actuation lever 43 to trigger the switch 45 for turning on/off the working unit 6.

To operate with both hands, as shown in the FIG. 6B, the user grasps the first handle 3 with one hand, such as the left hand as shown in the drawings, and also grasps the second handgrip portion 4b of the second handle 4 with another hand, such as the right hand. Ergonomically, the most comfortable position is that the distance between the two hands of the user is substantially equal to the width of his/her shoulders, and the arms are kept parallel to each other. The rotatability and angular position adjustability of the first and second handles 3, 4 with respect to he operation rod 2 allows different users to find the most comfortable position for operating the line trimmer 1.

The user's hand that grasps the second handgrip 4b of the second handle 4 can thus depress the second actuation lever 44 to trigger the switch 45 for turning on/off the working unit 6.

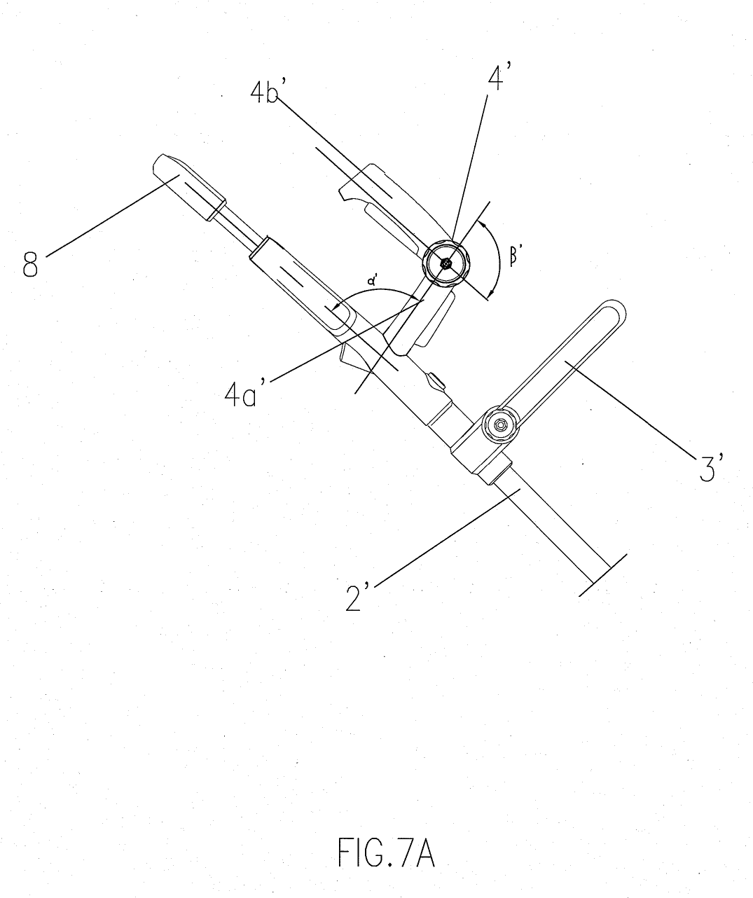

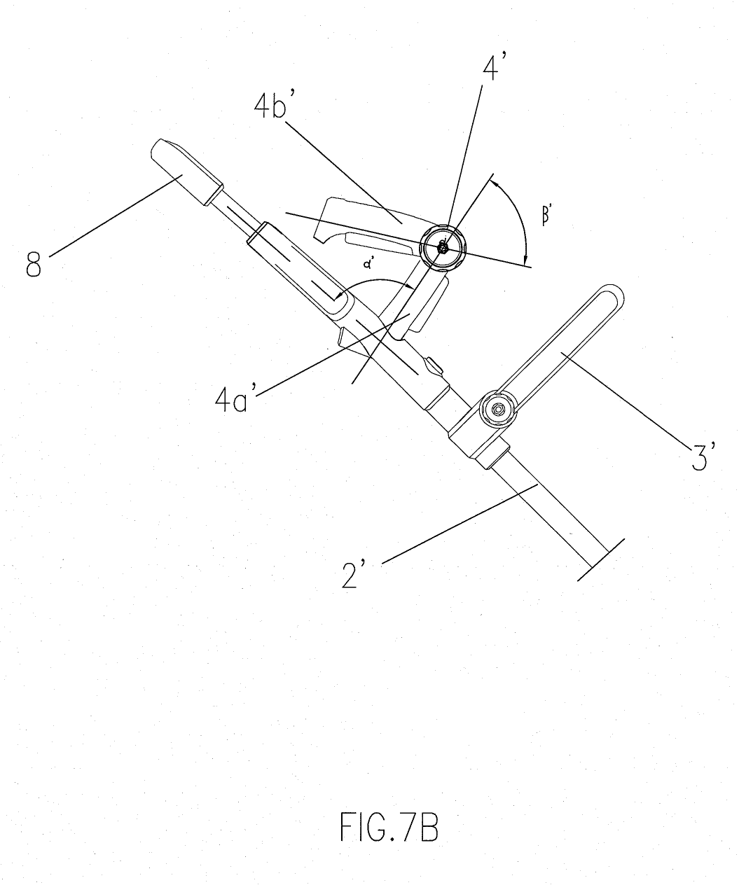

Referring to FIGS. 7A and 7B, which illustrate a line trimmer constructed in accordance with a second embodiment of the present invention, the second embodiment is a modification of the previous embodiment with reference to FIGS. 2A and 2B and thus the constructions are similar to each other with corresponding parts/components bearing identical reference numerals with a prime added for the second embodiment. To simplify the description, those parts/components that are identical will not be described again. The difference between the first and second embodiments of the line trimmer resides in that the handgrip portion 4a′ of the second handle 4′ of the second embodiment is fixedly mounted to the operation rod 2′ and is no longer rotatable with respect to the operation rod as illustrated in the previous embodiment and that the second handgrip portion 4b′ of the second handle 4′ of the second embodiment is made rotatable with respect to the first handgrip portion 4a′. With such an arrangement, the first included angle between the first handgrip portion 4a′ and the operating rod 2′, which is now designated α′, is fixed and is set in the region between 80 to 110 degrees, preferably 90 degrees. The second included angle between the first handgrip portion 4a′ and second handgrip portion 4b′, which is designated β′ in this embodiment, is now adjustable by the relative rotation between the first and second handgrip portions 4a′, 4b′ and can be selectively secured at any desired relative angular position. The first handle 3′ is constructed exactly the same as the first handle 4 of the previous embodiment.

As shown in FIG. 7A, to operate the line trimmer of the second embodiment with a single hand, the user grasps the first handgrip portion 4a′ of the second handle 4′ with the hand, and the forearm is placed on and supported by the forearm support 8. As shown in the FIG. 7B, to operate with both hands, the user angularly adjusts the second handgrip portion 4b′ with respect to the first handgrip portion 4a′ to a desired position, and then holds the first handle 3′ and the second handgrip portion 4b′ of the second handle 4′ with both hands.

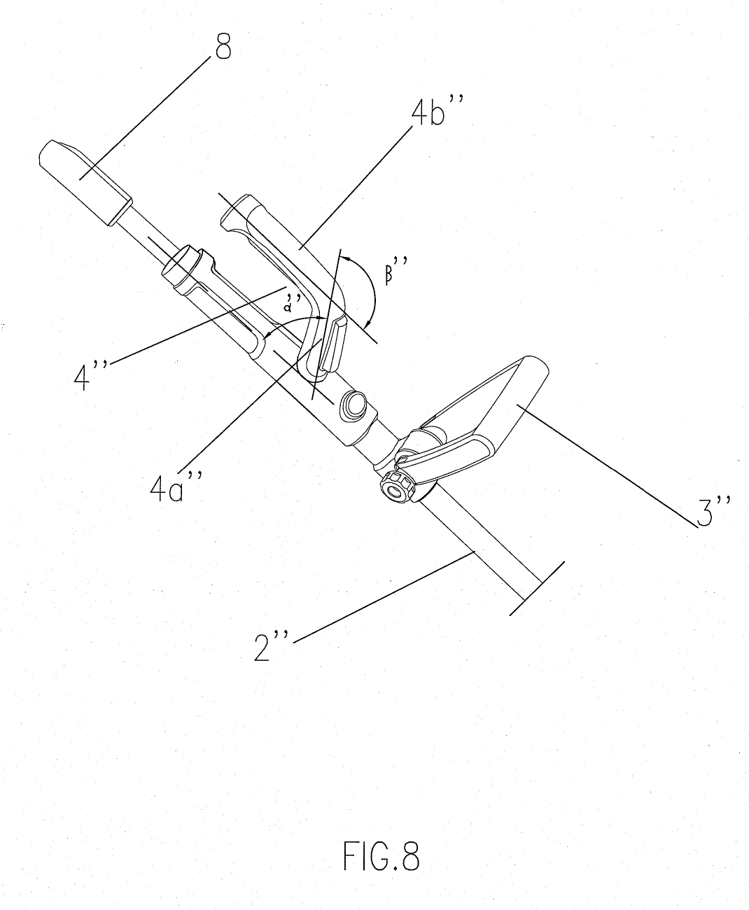

FIG. 8 illustrates a line trimmer constructed in accordance with a third embodiment of the present invention. The construction of the second embodiment is substantially identical to the previous embodiments with the modification that the second handle, which is now designated with reference numeral 4″ is completely fixed. In other words, the second handle 4′ has a first handgrip portion 4a″ that is fixedly attached to an operation rod 2″ of the line trimmer of the third embodiment and a second handgrip portion 4b″ that is fixedly attached to the first handgrip portion 4b″ so that adjustment of angular position of either the first handgrip portion 4a″ or the second handgrip portion 4b′ is no longer possible in this embodiment. In this case, a first included angle α″ between the first handgrip portion 4a′″ and the operation rod 2″ is fixed and is set in the range between 80 to 110 degrees and similarly, a second included angle β″ between the first handgrip portion 4a′″ and second handgrip portion 4b″ is fixed and is set in the range between 80 to 110 degrees.

The second handgrip portion 4b″ has a free end, which is now set in a fixed position with respect to the operation rod 2″. In this case, the height of the first handgrip portion 4a″ is preferably set equal to or slightly greater than the width of the user's palm for easy, comfortable, and stable gripping. Yet, it is obvious that the construction of the line trimmer of the third embodiment will be less comfortable for users than the foregoing embodiments.

The line trimmer of the third embodiment is still provided with an angular position adjustable first handle 3″ to allow for adjustability. Apparently, the first handle can be made fixed, if desired, while the second handle is angular position adjustable as illustrated previously.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A hand-held tool comprising:
an elongated operation rod;
a first handle coupled to the operation rod;
a second handle coupled to the operation rod; and
a working unit mounted to an end of the operation rod;
wherein the second handle comprises a first handgrip portion coupled to the operation rod with a first included angle therebetween and a second handgrip portion coupled to the first handgrip portion with a second included angle therebetween, the second handgrip portion having a free end.

2. The hand-held tool as claimed in claim 1, wherein the first and second handgrip portions and the operation rod are coupled so that at least one of the first and second included angles is adjustable.

3. The hand-held tool as claimed in claim 1, wherein the first handgrip portion is rotatably mounted to the operation rod so as to render the first included angle adjustable.

4. The hand-held tool as claimed in claim 3, wherein the first included angle is adjustable within a range between 80 to 110 degrees.

5. The hand-held tool as claimed in claim 1, wherein the first included angle is 90 degrees.

6. The hand-held tool as claimed in claim 4, wherein the first included angle is 90 degrees.

7. The hand-held tool as claimed in claim 1, wherein the second handgrip portion is rotatably mounted to the first handgrip portion so as to render the second included angle adjustable.

8. The hand-held tool as claimed in claim 7, wherein the second included angle is adjustable within a range between 80 to 110 degrees.

9. The hand-held tool as claimed in claim 1, wherein the second included angle is 90 degrees.

10. The hand-held tool as claimed in claim 8, wherein the second included angle is 90 degrees.

11. The hand-held tool as claimed in claim 1, wherein the first handgrip portion is fixedly mounted to the operation rod and wherein the second handgrip portion is fixedly mounted to the first handgrip portion.

12. The hand-held tool as claimed in claim 11, wherein the first included angle between the first handgrip portion and the operation rod is within a range between 80 to 110 degrees and wherein the second included angle between the second handgrip portion and the first handgrip portion is within a range between 80 to 110 degrees.

13. The hand-held tool as claimed in claim 12, wherein the first included angle is 90 degrees.

14. The hand-held tool as claimed in claim 12, wherein the second included angle is 90 degrees.

15. The hand-held tool as claimed in claim 1 further comprising an forearm support mounted to an opposite end of the operation rod and adapted to support a forearm of a user that operates the hand-held tool with a single hand holding the first handgrip portion of the second handle.

16. The hand-held tool as claimed in claim 15, wherein the forearm support is movable with respect to the operation rod.

17. The hand-held tool as claimed in claim 16, wherein the forearm support is movably mounted to the operation rod and a distance between the forearm support and the second handle is adjustable.

18. The hand-held tool as claimed in claim 15, wherein the first and second handles are spaced from each other along the operation rod and wherein the second handle is close to the forearm support while the first handle is away from the forearm support.

19. The hand-held tool as claimed in claim 1, wherein the first handle is rotatably mounted to the operation rod.

20. The hand-held tool as claimed in claim 19, wherein the first and second handles are spaced from each other and are adapted to be held by two hands of a user, respectively, who operates the tool with both hand.

21. The hand-held tool as claimed in claim 1, wherein the first handgrip portion of the second handle has a dimension measured from the operation rod to the second handgrip portion is sufficient to receive a palm of a user.

22. The hand-held tool as claimed in claim 1, wherein the hand-held tool is a garden tool.

23. The hand-held tool as claimed in claim 1, wherein the hand-held tool is a vegetation line trimmer.
